(19) United States
(12) Patent Application Publication
(10) Pub. No.: US 2008/0250762 A1
(43) Pub. Date: Oct. 16, 2008

(54) Dust Collector Tube Line Cleaner

(75) Inventor: John Brown, High View, WV (US)

Correspondence Address: UNGARETTI & HARRIS LLP;INTELLECTUAL PROPERTY GROUP - PATENTS, 70 WEST MADISON STREET, SUITE 3500, CHICAGO, IL, 60602-4224, US

(73) Assignee: MIDWESCO FILTER RESOURCES, INC., Niles, IL (US)

(21) Appl. No.: 11/733,315

(22) Filed: Apr. 10, 2007

(51) Int. Cl. B01D 46/00

(52) U.S. Cl. 55/283

(57) ABSTRACT

An apparatus for cleaning a differential pressure line in a pressure monitoring system is described. The cleaning apparatus has a first fluid pressure inlet, a second fluid pressure inlet, a flow control, and a means for controlling the flow control. The flow control has a first port in fluid communication with the fluid pressure inlet and a second port in selectable fluid communication with the second fluid pressure inlet and a third port in selectable fluid communication with the first pressure inlet. The means for controlling the flow control allows the flow control to selectively receive a reverse-flow fluid pressure via the second fluid pressure inlet and selectively distribute the reverse-flow fluid pressure to the fluid pressure inlet via the first port.

### TECHNICAL FIELD

The present invention relates to filter system monitoring devices. More particularly, the present invention is directed to an apparatus for monitoring differential pressure in a filter system with a device for flushing differential pressure monitoring tube lines.

### BACKGROUND OF THE INVENTION

Dust collection or recovery systems, such as baghouses, are used for the removal of particulates and non-particulates from a fluid stream to prevent the particulates and non-particulates from exhausting into the atmosphere. The fluid stream may contain dust and gas which is conveyed to a baghouse or other similar air or gas filtering system. The dust and gas are separated by a filter elements. The dust is collected for later use while cleaned gases are vented to the atmosphere.

Typically, particle-laden gases are drawn through the baghouse from an inlet to an outlet. Inside a baghouse, there are a number of fabric filters (bags) suspended in a baghouse chamber. The filter bags are generally two or more sided mesh-like structures with a central opening. Certain flow paths through the filter bags tend to cause them to collapse, so frames are frequently utilized to support the interior of the bags to ensure they remain in an open, expanded position irrespective of flow path.

The baghouse operates by allowing the gas stream to pass through the walls of the bags, catching the particles on the bag's walls. Thus, if the flow of dirty air is from outside the bag (to the inside of the bag and out an outlet), particles will be caught on the outer surface of the bag. As noted, the bags typically have a mesh or screen size. Thus, particles larger than the mesh or screen side are caught on and in the exposed bag surface.

Environmental regulations make it imperative to monitor baghouse performance. This is typically done by measuring differential pressures in predetermined locations in the baghouse. Any number of high/low pressure lines can be provided at different locations within the baghouse. For instance, the differential pressure may be measured between the inlet of the baghouse and the outlet of the baghouse, or the differential pressure might be measured above and below the tube sheet which suspends the filtering bags in the baghouse.

The lines are joined to a control box where devices such as photohelics, magnehelics, pressure switches, or other gauges measure the differential pressure from a high pressure (dirty) line to a low pressure (clean) line. These monitoring devices are very sensitive to pressure. To prevent failure, the devices must be properly maintained. Thus, the lines must be cleaned regularly to keep debris from clogging the lines.

The present invention is provided to solve the problems discussed above and other problems, and to provide advantages and aspects not provided by prior dust collectors of this type. A full discussion of the features and advantages of the present invention is deferred to the following detailed description, which proceeds with reference to the accompanying drawings.

### SUMMARY OF THE INVENTION

One aspect of the present invention is directed to an apparatus for cleaning a differential pressure line in a pressure monitoring system. The apparatus comprises a first fluid pressure inlet, a second fluid pressure inlet, a flow control, and a means for controlling the flow control. The flow control has a first port in fluid communication with the fluid pressure inlet and a second port in selectable fluid communication with the second fluid pressure inlet and a third port in selectable fluid communication with the first pressure inlet;. The means for controlling the flow control allows the flow control to selectively receive a reverse-flow fluid pressure via the second fluid pressure inlet and selectively distribute the reverse-flow fluid pressure to the fluid pressure inlet via the first port.

The flow control may be a valve, and the apparatus may further comprise a communication link between the pressure monitoring system and the means for controlling the valve. The communication link provides a first signal to the means for controlling the valve wherein the means for controlling the valve is responsive to the first signal. The valve may include a solenoid responsive to a second signal provided by the means for controlling the flow control. The first signal may be dependent on an elapsed time duration.

The reverse-flow fluid pressure may be prohibited from fluid communication with the third port of the valve.

The means for controlling the flow control may include a mechanical switch.

The means for controlling the flow control may include a programmable logic controller.

The means for controlling the flow control may include a solid state relay.

The apparatus may further comprise a fluid pressure outlet in selective fluid communication with the first fluid pressure inlet via the first and third ports in the flow control. The means for controlling the flow control may selectively activate the second and third flow control ports, obstructing the second flow control port to reduce fluid communication to at least a negligible level between the first fluid pressure inlet and the first fluid pressure outlet while allowing fluid communication between the first fluid pressure inlet and the second fluid pressure inlet by reducing an obstruction in the second port to allow the reverse-flow fluid pressure to flush the first fluid pressure inlet.

Another aspect of the invention is directed to an apparatus for flushing pressure lines. The apparatus comprises a plurality of pressure lines, a reverse flow pressure line, a valve means, a control means. Each of the plurality of pressure lines transfers a forward fluid pressure therethrough. The valve means is in fluid communication with the plurality of pressure lines and the reverse-flow pressure line. The valve means selectively controls a reverse-flow fluid pressure from the reverse-flow fluid pressure line to at least one of the plurality of pressure lines to back-flush the at least one of the plurality of pressure lines. The control means delivers a signal to the valve means. The signal activates the valve means to selectively place the reverse-flow fluid pressure in fluid communication with the at least one of the plurality of pressure lines wherein the reverse-flow fluid pressure back flushes the at least one of the plurality of pressure lines.

At least one of the plurality of fluid pressure lines may be an output line from the valve means in selective communication with another of the at least one of the plurality of fluid pressure lines.

The control means may include a programmable logic controller.

The valve means may include a solenoid responsive to the signal from the control means, wherein in an open condition the solenoid allows the reverse-flow fluid pressure.

Another aspect of the present invention is directed to a dust collection apparatus. The dust collection apparatus comprises a fluid pressure inlet, a fluid pressure outlet, a filter element located between the fluid pressure inlet and the fluid pressure outlet, a first fluid pressure line joined to the dust collection apparatus between the fluid pressure inlet and the fluid pressure outlet, an atmospheric sensitive device for measuring an atmospheric condition within the dust collection apparatus joined to the first fluid pressure line, a source of an external fluid pressure, and a means for providing the external fluid pressure to the first fluid pressure line wherein the first fluid pressure line is back-flushed by a reverse-flow fluid pressure provided by the external source of fluid pressure.

In this aspect of the invention, the means for providing the external fluid pressure to the first fluid pressure line may comprise a flow control located between a portion of the first fluid pressure line and the atmospheric sensitive device. The flow control is for selective removal of a forward fluid pressure from the first fluid pressure line to the atmospheric sensitive device.

The means for providing the external fluid pressure to the first fluid pressure line may further comprises a control means for directing a signal to the flow control to selectively place the reverse-flow fluid pressure into fluid communication with the first fluid pressure line.

The flow control may be a valve. The valve may have a first port in fluid communication with the first fluid pressure line and a second port in selectable fluid communication with the source of an external fluid pressure.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a schematic drawing of dust collection system;

FIG. 2 is a schematic diagram of a monitoring system with a tube line cleaner;

FIG. 3 is a schematic diagram of a monitoring system with an alternative tube line cleaner; and

FIG. 4 is a schematic diagram of a monitoring system with yet another alternative tube line cleaner.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

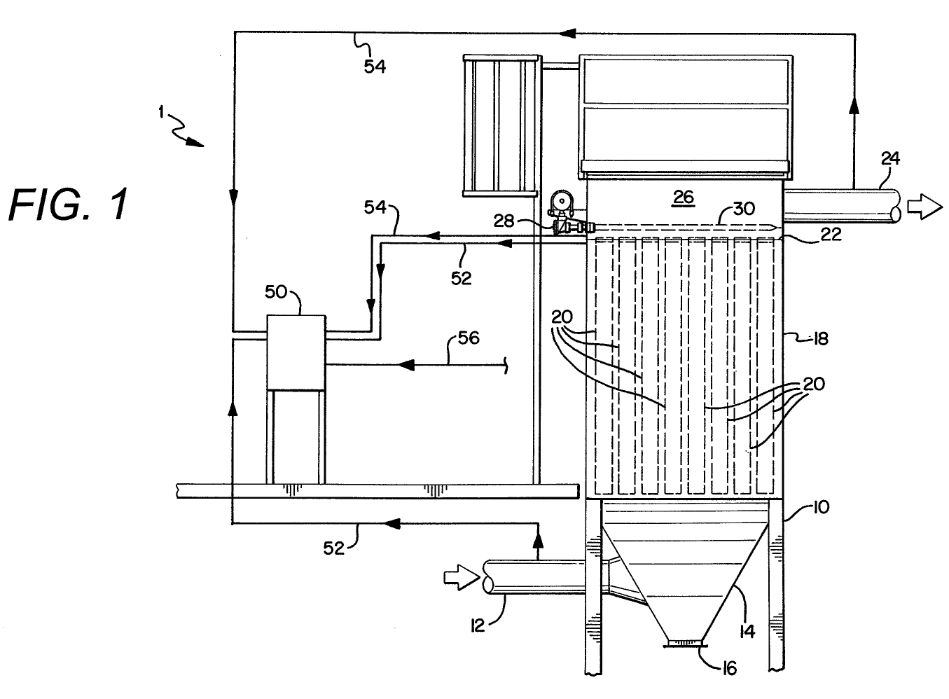

Referring to FIG. 1 a dust collection system 1 comprises a enclosed filter-bearing housing, such as a baghouse 10, and a pressure monitoring system 50. While a pulse jet cleaning system baghouse 10 is illustrated, it should be appreciated that unless otherwise claimed, the dust collection system 1 of the present invention may include any type of filter-bearing housing apparatus having any type of filtering medium without departing from the spirit of the invention.

The baghouse 10 generally includes an inlet 12 joined to a frustoconical hopper 14 having a dust discharge port 16 at a lowermost end. The hopper 14 opens to a baghouse chamber or filter housing 18. One or more filter bags 20 are disposed within the filter housing 18. The embodiment illustrated includes eight filter bags 20; however, one ordinary skilled in the art would appreciate that any number of filtering elements could be provided without departing from the spirit of the invention. Also, the baghouse 10 may include any number of filter housings.

The filter bags 20 are suspended from a tube sheet 22. The tube sheet 22 includes apertures to allow fluid flow from the inlet 12 through the filter bags 20 and the tube sheet 22 before being expelled from the baghouse 10 via an outlet 24.

A clean air plenum 26 is disposed above the tube sheet 22, and a pulse jet cleaning system is provided to blow a fluid pressure in a reverse flow to remove particulate matter from the filter bags 20. This type of reverse flow cleaning is typical in the art. Generally, a source of fluid pressure is attached to an air header 28 and is delivered to the clean air plenum via a blow pipe 30.

Dust collection systems 1 such as the one illustrated often include monitoring systems 50 which track differential fluid pressure within the baghouse 10. Pressure lines attached at various points along the baghouse 10 transfer a fluid pressure to a monitoring device which measures the differential pressure between discreet points within the baghouse. Typically, high pressure lines 52 associated with the inlet 12 and low pressure lines 54 associated with the outlet 14 transfer an outward or forward fluid pressure from the baghouse 10 to the monitoring device 50. The direction of the fluid pressure is shown by arrows on each line 52,54.

The monitoring system 50 is often used to make decisions based upon system, departmental, and./or compartmental pressure variations. However, because the environment under which this monitoring system 50 operates is hostile and dirty, the accuracy with which the monitoring system 50 is able to track the pressure variations is often adversely affected by particulate matter trapped in the high and low pressure lines 52 and 54.

One aspect of the present invention provides a tube line cleaner in conjunction with the monitoring system. The tube line cleaner disclosed herein is illustrated and described in connection with the duct collection system 1; however, one ordinary skilled in the art would appreciate that the tube line cleaner of the present invention is suitable for a wide range of applications where pneumatic tubing must remain clear from blockage.

The tube line cleaner is designed to back flush (using a reverse-flow fluid pressure, such as compressed air) moisture, debris, or a blockage in a fluid line. The tube line cleaner of the present invention stops the fluid pressure to a gauge or other measuring instrument and introduces a reverse-flow fluid pressure, generally a compressed air, into the fluid pressure line(s) thereby removing, by back-flushing, any debris and/or moisture in the fluid pressure line(s). The device uses a controller and/or relay timer to stop the flow to the measuring instrument, and open up pressure lines to a source of the reverse-flow fluid pressure. The tube line cleaner can be sized from individual lines to multiple lines. The tube line cleaner can also be set to pulse at desired intervals as well as manually. This is accomplished by using flow control devices or valve means, such as solenoids, that stop the fluid pressure to the measuring devices and allow the reverse-flow to flush the pressure line(s).

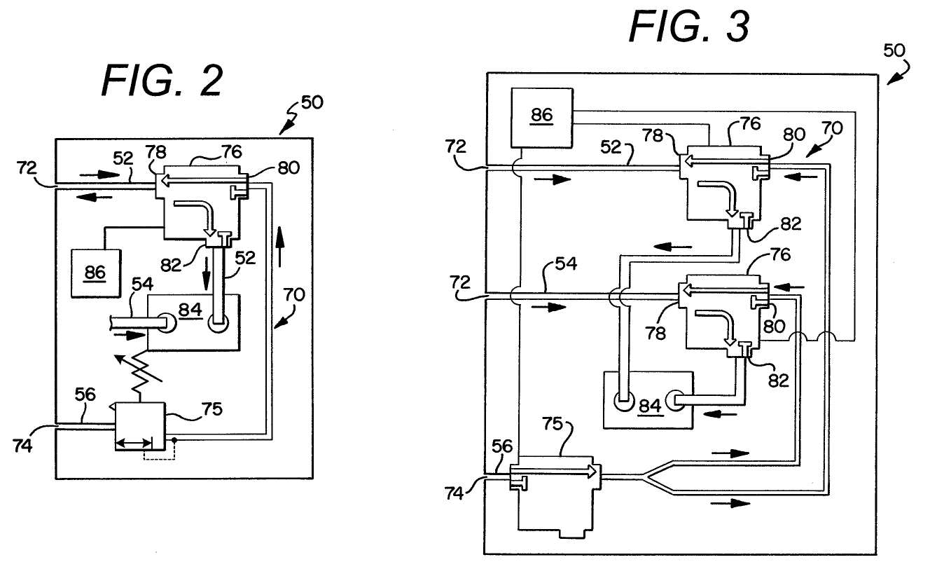

Referring generally to FIGS. 2-4, a tube line cleaners 70 of the present invention are illustrated. A plurality of pressure lines and at least one reverse-flow fluid pressure line are in fluid communication with a valve means. The valve means selectively controls a reverse-flow fluid pressure from the reverse-flow fluid pressure line to at least one of the plurality of pressure lines to back-flush that pressure line. A control means delivers a signal to the valve means to activate the valve means to selectively place the reverse-flow fluid pressure in fluid communication with the pressure line or lines to be back flushed.

Referring to FIG. 2, a single channel tube line cleaner 70 for cleaning differential pressure lines in a pressure monitoring system 50 is illustrated. This device includes a fluid pressure inlet 72 which is associated with the baghouse 10 and adapted to receive a fluid pressure therefrom, typically the high pressure (or dirty) line 52. A second fluid pressure inlet 74 is adapted to receive a reverse-flow fluid pressure from an external source of a fluid pressure 56 including via a pressure regulator 75. Arrows indicate the fluid pressure flow with in the system 50.

The tube line 70 further comprises a flow control such as a valve 76 having multiple ports. A first port 78 is in selectable fluid communication with the fluid pressure inlet 72 associated with the baghouse 10. A second port 80 is in selectable fluid communication with the fluid pressure inlet 74 associated with the external source of a reverse-flow fluid pressure 56. A third port 82 is in selectable fluid communication with a fluid pressure outlet associated with an atmospheric sensitive measuring device 84, such as a pressure gauge, photohelic, magnehelic, pressure switch, thermometer, or other gauge.

A means for controlling 86 the valve 76 ports is also included. The means for controlling 86 the valve 76 determines whether a fluid pressure is transferred in a forward direction from the first port 78 to the third port 82 or whether a reverse-flow fluid pressure is transferred or distributed via the second port 82 to the first port 78 to back-flush the fluid pressure inlet 72 and the fluid pressure line associated with the baghouse 50.

The control means 86 selectively activates and deactivates the second and third valve ports 80,82, obstructing the second valve port 80 to reduce fluid communication to at least a negligible level between the first fluid pressure inlet 72 and the second port 80. It further allows fluid communication between the first fluid pressure inlet 72 and the second fluid pressure inlet 74 by reducing an obstruction in the second port 80 to allow the reverse-flow fluid pressure from the second fluid pressure inlet 74 to back-flush the first fluid pressure inlet. 72.

The control means 86 may output a signal to the valve which opens and closes the ports 78,80,82. Accordingly, the valve 86 may include solenoids responsive to the signal received from the control means 86, wherein in an open condition the solenoid allows the reverse-flow fluid pressure. The control means 86 may operate based on time duration, or it may receive a signal dependent on a differential atmospheric condition from the atmospheric sensitive measuring device 84. The control means 86 may be a programmable logic controller, a mechanical switch, time relay, an electromechanical switch, or an other suitable device for controlling the valve 76. Preferably, the control means 86 is some combination of the aforementioned devices, most preferably a solid-state relay, a PLC, such as the AB 1760-L12AWA-ND, a selector switch and push/bottom pilot light.

The solid state relay serves several purposes. It greatly increases the life of the PLC output contacts by switching the power to the valve. Thus, the PLC does not have to control an inductive load. Also, the solid-state relay reduces electromagnetic interference. The solid-state relay has zero switching characteristics. This means that power to the valve 76 is applied while the AC voltage is at zero, greatly decreasing electromagnetic noise and surges.

A selector switch may be used to select one of two or more cycles, e.g. a 12 hour or 24 hour repeat cycle. The push button/pilot light combination serves several functions. When the push button is depressed, a manual cycle is initiated with the timing based on the position of the selector switch. The pilot illuminates when a cycle is in progress, regardless of whether it was a manual cycle or a repeat cycle. Starting a manual cycle does not interfere with the normal repeat cycle, and once a cycle is started, the selector switch is disabled until the cycle is complete.

With no cycle in progress, the first port 78 is open to the baghouse line 52 and the third port 82 is open to the measuring device 84. Once in progress, the third port 82 is closed. The second port 82 opens resulting in the flushing of the fluid pressure line 52 to the baghouse 10. Once the cycle is complete, the first and third ports 78,82 are once again open.

Referring to FIG. 3, an alternative embodiment of a single channel tube line cleaner 70 for cleaning differential pressure lines in a pressure monitoring system 50 is illustrated. This device differs from the device of FIG. 2. in that both low (dirty) and high (clean) fluid pressure lines 52,54 associated with the baghouse 10 can be back-flushed with a reverse-flow fluid pressure. Accordingly, this device includes a pair of fluid pressure inlets 72 associated with the baghouse 10 and a pair of valves 76 to accommodate each baghouse fluid pressure line 52,54

This embodiment further includes a pressure regulator 75 capable of receiving a signal from the control means 86 for activating and deactivating the reverse-flow fluid pressure from the external source of fluid pressure to the second port 80. Accordingly, the regulator my include a solenoid responsive to the signal.

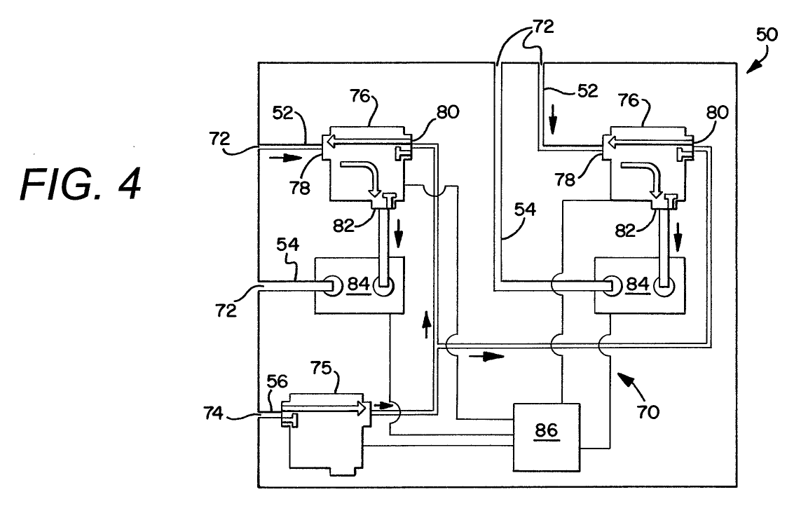

A multi-channel tube line cleaner 70 is illustrated in FIG. 4. This embodiments is particularly adapted for back-flushing multiple baghouse fluid pressure lines either from differential pressure lines monitoring pressure differentials at multiple points in a baghouse with a single baghouse chamber 18 or monitoring pressure differentials in a baghouse having multiple baghouse chambers 18. Accordingly, the multi-channel system also includes multiple atmospheric measuring devices 84. The embodiment illustrated is a two-channel tube line cleaner; however, one ordinary skilled in the art would recognize that a plurality of channels could be provided. This embodiment further illustrates the atmospheric measuring devices 84 in communication with the control means 86 to provide a signal to the control means 86. This signal may be provide via communication link, and the control means 86 is responsive to said first signal.

While the specific embodiments have been illustrated and described, numerous modifications come to mind without significantly departing from the spirit of the invention, and the scope of protection is only limited by the scope of the accompanying Claims.

What is claimed is:

1. An apparatus for cleaning a differential pressure line in a pressure monitoring system, the apparatus comprising:
a first fluid pressure inlet;
a second fluid pressure inlet;
a flow control having a first port in fluid communication with said fluid pressure inlet and a second port in selectable fluid communication with said second fluid pressure inlet and a third port in selectable fluid communication with said first pressure inlet; and
a means for controlling the flow control to selectively receive a reverse-flow fluid pressure via said second fluid pressure inlet and selectively distribute said reverse-flow fluid pressure to said first fluid pressure inlet via said first port.

2. The apparatus of claim 1 wherein said flow control is a valve.

3. The apparatus of claim 2 further comprising a communication link between said pressure monitoring system and said means for controlling said flow control, said communication link providing a first signal to said means for controlling said flow control wherein said means for controlling said flow control is responsive to said first signal.

4. The apparatus of claim 3 wherein said valve includes a solenoid responsive to a second signal provided by said means for controlling said flow control.

5. The apparatus of claim 3 wherein said first signal is dependent on an elapsed time duration.

6. The apparatus of claim 1 wherein said reverse-flow fluid pressure is prohibited from fluid communication with said third port of said valve.

7. The apparatus of claim 1 wherein said means for controlling said flow control includes a mechanical switch.

8. The apparatus of claim 1 wherein said means for controlling said flow control includes a programmable logic controller.

9. The apparatus of claim 1 wherein said means for controlling said flow control includes a solid state relay.

10. The apparatus of claim 1 further comprising a fluid pressure outlet in selective fluid communication with said first fluid pressure inlet via said first and third ports in said valve.

11. The apparatus of claim 10 wherein said means for controlling said flow control selectively activates said second and third flow control ports, obstructing said second flow control port to reduce fluid communication to at least a negligible level between said first fluid pressure inlet and said first fluid pressure outlet while allowing fluid communication between said first fluid pressure inlet and said second fluid pressure inlet by reducing an obstruction in said second port to allow said reverse-flow fluid pressure to flush said first fluid pressure inlet.

12. An apparatus for flushing pressure lines, the apparatus comprising:
a plurality of pressure lines each transferring a forward fluid pressure therethrough;
a reverse-flow pressure line;
valve means in fluid communication with said plurality of pressure lines and said reverse-flow pressure line, said valve means for selectively controlling a reverse-flow fluid pressure from said reverse-flow fluid pressure line to at least one of said plurality of pressure lines to back-flush said at least one of said plurality of pressure lines; and
control means for delivering a signal to said valve means, said signal activating said valve means to selectively place said reverse-flow fluid pressure in fluid communication with said at least one of said plurality of pressure lines wherein said reverse-flow fluid pressure back flushes said at least one of said plurality of pressure lines.

13. The apparatus of claim 12 wherein at least one of said plurality of fluid pressure lines is an output line from said valve means in selective communication with another of said at least one of said plurality of fluid pressure lines.

14. The apparatus of claim 12 wherein said control means includes a programmable logic controller.

15. The apparatus of claim 12 wherein said valve means includes a solenoid responsive to said signal from said control means, wherein in an open condition said solenoid allows said reverse-flow fluid pressure.

16. A dust collection apparatus comprising:
a fluid pressure inlet;
a fluid pressure outlet;
a filter element located between said fluid pressure inlet and said fluid pressure outlet;
a first fluid pressure line joined to said dust collection apparatus between said fluid pressure inlet and said fluid pressure outlet;
an atmospheric sensitive device for measuring an atmospheric condition within said dust collection apparatus joined to the first fluid pressure line;
a source of an external fluid pressure; and
a means for providing said external fluid pressure to said first fluid pressure line wherein said first fluid pressure line is back-flushed by a reverse-flow fluid pressure provided by said external source of fluid pressure.

17. The dust collections apparatus of claim 16 wherein said means for providing said external fluid pressure to said first fluid pressure line comprises a flow control located between a portion of said first fluid pressure line and said atmospheric sensitive device, said flow control for selective removal of a forward fluid pressure from said first fluid pressure line to said atmospheric sensitive device.

18. The dust collection apparatus of claim 17 wherein said means for providing said external fluid pressure to said first fluid pressure line further comprises control means for directing a signal to said flow control to selectively place said reverse-flow fluid pressure into fluid communication with said first fluid pressure line.

19. The dust collection apparatus of claim 18 wherein said flow control is a valve.

20. The dust collection apparatus of claim 19 wherein said valve has a first port in fluid communication with said first fluid pressure line and a second port in selectable fluid communication with said source of an external fluid pressure.
